(19) United States
(12) Patent Application Publication
(10) Pub. No.: US 2025/0000096 A1
(43) Pub. Date: Jan. 2, 2025

(54) ANTIMICROBIAL COMPOSITION WITH A LOW ODOR

(71) Applicant: EVONIK CORPORATION, Piscataway, NJ (US)

(72) Inventors: Weidong An, Williamsville, NY (US); Ricky Mittiga, Fort Mill, SC (US); Elena Pisanova, Amherst, NY (US); John M. Rovison, JR., Sanborn, NY (US)

(73) Assignee: EVONIK CORPORATION, Piscataway, NJ (US)

(21) Appl. No.: 18/576,786

(22) PCT Filed: Jul. 7, 2022
(86) PCT No.: PCT/US2022/073516

§ 371 Date: Jan. 5, 2024

(30) Foreign Application Priority Data
Jul. 9, 2021 (EP) 21184646.4

(51) Int. Cl. A01N 59/00; A01N 25/02; A01N 37/04; A01P 1/00; A23B 4/20; A23B 4/24; A23L 3/3508; A23L 3/358

(52) U.S. Cl. CPC A01N 59/00; A01N 25/02; A01N 37/04; A01P 1/00; A23B 4/20; A23B 4/24; A23L 3/3508; A23L 3/358

(57) ABSTRACT

An aqueous antimicrobial composition is made with a low odor that has (a) a first volatile carboxylic acid, (b) a second non-volatile carboxylic acid, (c) a first percarboxylic acid, (d) a second percarboxylic acid, and (e) hydrogen peroxide. The molar ratio of the sum of the first carboxylic acid and the first percarboxylic acid to the sum of the second carboxylic acid and the second percarboxylic acid is from 1:5 to 5:1, preferably from 1:3 to 3:1. Processes are developed for producing the composition and sanitizing various surfaces with it.

### FIELD OF THE INVENTION

The invention relates to an antimicrobial composition containing peracids, to methods of making this composition and to methods of using the composition in antimicrobial treatment.

The composition generates little or no odor and can be safely used to decontaminate substances without degrading their organoleptic properties. Substances that may be treated include foods, such as meats, fruits, vegetables, and grains, beverages and packaging. The disclosed composition can also be used for any other antimicrobial treatment where non-detectable to minimum odor generation is desirable.

### BACKGROUND OF THE INVENTION

The processing of food products often leads to bacterial contamination both from the workers involved and from processing equipment, as well as from the food products themselves. Antimicrobial agents are therefore used during processing to reduce contamination, especially from potentially pathogenic bacteria such as E. coli and Salmonella.

Peracetic acid (PAA) is one of several biocides that have been approved for direct application to meat, poultry and other products. Unfortunately, due to the very low (0.15 ppm) limit for olfactory detection of PAA and acetic acid, these biocides are often unpleasant for workers to use. They also pose a safety hazard due to their volatility and tendency to irritate the eyes, lungs and skin of workers. In addition, PAA biocides may alter the organoleptic properties of food products (e.g., the texture, color, appearance or taste of meat proteins), thereby reducing product quality.

Various peracids have been investigated that could be used in the place of PAA for antimicrobial applications. These peracids are typically synthesized from hydrogen peroxide and organic acids and, in some instances, have been demonstrated to be highly effective against hard to kill microorganisms. For example, percitric acid (PCA) was shown to have a higher virucidal efficacy than PAA (P. Wutzler, et al., Ltrs. App. Micmbiol. 39:194-198 (2004)), as well as high sporicidal efficacy (P. Wutzler, et al., J. Hosp. Infect. 79:75-76 (2005)). In addition, performic acid (PFA) and perpropionic acid (PPA) were found to be highly effective in the reduction of E. coli and enterococci in wastewater (Luukkonen, et al., Water Res. 85:275-285 (2015)).

Peracids are usually produced by the reaction of the corresponding carboxylic acids with hydrogen peroxide (HP) in the presence of sulfuric acid, which acts as a catalyst, as shown by the equation below:

R—COOH+H₂O₂↔R—COOOH+H₂O

The reaction is an equilibrium and is driven to the right by removal of water or using excess reagents.

Most peracids, including PCA (percitric), PPA (perpropanoic), PLA (perlactic acid), and performic acid (PFA) are unstable and become even less stable when diluted. Therefore, mixing the components of a peracid solution may be delayed until at, or near, the time of use. However, on-site blending increases the cost of food processing and the likelihood of accidents or injuries due to the additional handling of reagents. Accordingly, pre-blending of the raw materials into a finished concentrate composition is generally preferred. Pre-blending is also desirable because it provides consistency in the concentration of the antimicrobial agent applied to foods and beverages.

Several attempts have been made to maintain the effectiveness of aqueous peracid solutions using stabilizers. For example, tertiary alcohols have been suggested for use as solvents to stabilize long-chain and/or cyclic peracids, such as peroxybenzoic, peroxylauric, and peroxycyclohexanoic acids (U.S. Pat. No. 3,180,169). Another approach was suggested in US 2014/0113967A1, in which peracids are stabilized by including them in a viscous matrix such as gels films, colloids based on xanthan, guar, or agar. However, this approach is not practical for food applications. Also, many stabilizers, such as primary and secondary alcohols, amines, and aldehydes, cannot be used, either because they interact with peroxycarboxylic acids or because of their toxicity or carcinogenicity.

There is a need for stable peroxyacid-based antimicrobial compositions having little or no odor, providing a balance between antimicrobial effectiveness, process safety, and quality of finished food products. They should reduce microbial load without negatively impacting worker safety or the environment and, at the same time, not alter the organoleptic properties of the food. In addition, the antimicrobial agent should be stable, environmentally compatible, and not generate toxic residues or byproducts. There is further a need for improved PAA compositions and compositions with other relatively volatile acid/peracids for use in the washing or processing of poultry, red meats, seafood, fruits, vegetables, grains, and aseptically packaged beverages.

### SUMMARY OF THE INVENTION

The present invention is based on the unexpected discovery that combining certain peracid precursors having low vapor pressures, such as acetic acid or lactic acid, with certain peracid precursors comprising at least two carboxylic groups, such as citric acid, and with aqueous hydrogen peroxide forms a stable peracid composition that has low or no odor and can be used for antimicrobial treatment of foods and beverages.

Unexpectedly, such compositions have both enhanced antimicrobial efficacy and shelf stability compared to the peracid with the one acid precursor alone and also have little or no odor. Not wishing to be bound to any particular theory, it is believed that improved antimicrobial efficacy of the compositions of the present invention is caused by synergistic biocidal action of different peracids. Such compositions allow for prolonged storage, transportation, and dilution of the concentrated compositions at the point of application provide high antimicrobial efficacy of the resulting diluted composition. Application of such diluted inventive compositions facilitates the sanitizing of meat proteins and other foods without altering their organoleptic properties.

### DESCRIPTION OF THE INVENTION

### The Aqueous Antimicrobial Composition

The object of the present invention is an aqueous antimicrobial composition, comprising
(a) a first carboxylic acid with a boiling point at standard pressure of below 180° C.,
(b) a second carboxylic acid comprising at least two carboxylic groups,
(c) a first percarboxylic acid derived from the first carboxylic acid,
(d) a second percarboxylic acid derived from the second carboxylic acid,
(e) hydrogen peroxide,
   wherein the molar ratio of the sum of the first carboxylic acid and the first percarboxylic acid to the sum of the second carboxylic acid and the second percarboxylic acid is from 1:5 to 5:1, preferably from 1:4.5 to 4.5:1, more preferably from 1:4 to 4:1, even more preferably from 1:3 to 3:1, and most preferably from 1:2 to 2:1 wherein the composition further comprises an inorganic acid.

The second carboxylic acid is different from the first carboxylic acid.

The terms “organic acid”, “acid” and “carboxylic acid” are used interchangeably in the present invention. The terms “peracid”, “peroxyacid”, “peroxycarboxylic acid” and “percarboxylic acid” are analogous and are also used interchangeably in the present invention.

The aqueous antimicrobial composition of the invention is usually prepared by mixing the first and the second carboxylic acids with an aqueous hydrogen peroxide solution. Thus, the first and the second carboxylic acids react with hydrogen peroxide and form the first and the second percarboxylic acids, respectively.

### The First Carboxylic Acid

The first carboxylic acid is relatively volatile and has a boiling point at standard pressure (b.p.) of below 180° C., preferably below 166° C., more preferably below 150° C., more preferably below 130° C.

The first carboxylic acid is preferably selected from formic acid (b.p.=101° C.), acetic acid (b.p.=118° C.), propionic acid (b.p. 141° C.), glyoxylic acid (b.p.=111° C.), glycolic acid (b.p.=100° C.), pyruvic acid (b.p.=165° C.), lactic acid (b.p.=122° C.), or mixtures thereof. Of these acetic acid and lactic acid are particularly preferred.

### The Second Carboxylic Acid

The second carboxylic acid is preferably selected from maleic acid, crotonic acid, malic acid, tartaric acid, malonic acid, citric acid or mixtures thereof. Of these citric acid is particularly preferred.

Particularly the compositions of the present invention employing citric, crotonic, malic and maleic acids as the second carboxylic acid have been found to be surprisingly stable. Because of the surprising stability of these compositions, they can be pre-blended, shipped and handled more easily and safely than other peracid compositions.

A particularly preferred composition comprises lactic and acetic acids as the first carboxylic acids and citric acid as the second carboxylic acid, and the peracids derived thereof.

The aqueous mixture comprising the first and the second carboxylic acids combined with hydrogen peroxide forms peracid-peroxide solutions that generate non-detectable to minimum odor. At the same time, the formed peracids may have a better affinity to the proteinaceous surfaces and achieve better efficacies against the target microorganisms than the typically used for in this field peracetic or performic acid.

Both the first and the second carboxylic acid used in the present invention are preferably well soluble in water, i.e. have the solubility of at least 10 g, more preferably at least 20 g, more preferably at least 30 g acid per 100 g water at 25° C.

The first and the second carboxylic acids are preferably suitable for the use in the food industry. More preferably, these carboxylic acids should be food grade or GRAS materials.

Such carboxylic acids and the peracids derived thereof are particularly suitable in food processing. Some of the preferred carboxylic acids are commercially available as derivatives of the natural materials, for example, tartaric acid is derived from grapes and malic acid is commercially derived from apples.

### Additives

The reaction between carboxylic acids and hydrogen peroxide can be accelerated by use of an inorganic acid, preferably a strong inorganic acid as a catalyst. Therefore, the composition according to the invention preferably further comprises an inorganic acid, which for instance may be selected from sulfuric acid, methane sulfonic acid, phosphoric acid, nitric acid.

The inventive composition may further comprise a peroxide stabilizer. All compounds generally suitable for stabilizing hydrogen peroxide and/or peracid solutions may be used as peroxide stabilizers in the inventive composition. Such compounds are generally known from the prior art. Particularly preferably, commercially available food additives can be used in the composition of the invention, such as organophosphonates sold under the trade name DEQUEST® including, for example, 1-hydroxyethylidene-1,1-diphosphonic acid (DEQUEST® 2010); amino(tri(methylene-phosphonic acid)), (N[CH₂PO₃H₂]₃, DEQUEST®2000); and/or ethylenediamine-[tetra(methylenephosphonic acid)](DEQUEST® 2041). Other suitable stabilizers include pyridine derivatives, such as dipicolinic acid, pyridine tricarboxylic acid, and pyridine tetrcarboxylic acid. The weight ratio of the employed stabilizer to the sum of all carboxylic acids and peracids in the composition is usually less than 1:50, more preferably less than 1:100.

Concentrations of the carboxylic acids, percarboxylic acids and hydrogen peroxide in the inventive composition are preferably close to the corresponding equilibrium concentrations thereof. The term “close to the equilibrium concentrations” means that the corresponding concentrations deviate by at most 10% from the corresponding equilibrium values at the used temperature. The corresponding equilibrium concentrations correspond to the ones in a system with the maximal concentrations of the peracids achieved after mixing the acids with hydrogen peroxide solution and reacting the mixture for a time necessary for achieving the maximal peracid concentration, while monitoring the concentrations of the peracids.

The equilibrium state is preferably achieved in the inventive composition prior to the use thereof for antimicrobial treatment. However, it is not necessary. It has been observed that the composition of the invention can be successfully employed for antimicrobial treatment even if the maximal concentration of the percarboxylic acids, i.e. the equilibrium state has not been achieved.

The molar ratio of the (carboxylic acids):(percarboxylic acids):(hydrogen peroxide) in the inventive composition is preferably (1.0-6.0):(1.0):(0.5-4.0), more preferably (1.5-3.0):(1.0):(1.5-3.0). This ratio ensures the optimum balance of biocidal efficacy of the antimicrobial composition and cost.

The absolute concentrations of the components of the composition may vary depending on the dilution extent thereof and on the intended application.

The content of percarboxylic acids in the composition is usually in the range 10 ppm to 40 wt %. The content of percarboxylic acids in the concentrated composition according to the invention may be from 1 wt % to 40 wt %, preferably 2 wt % to 30 wt %. The content of percarboxylic acids in the diluted composition of the invention may be from 10 ppm to 20,000 ppm, preferably 50 ppm to 5,000 ppm.

The aqueous antimicrobial composition according to the invention is typically characterized by a high stability during the storage. The high stability, e.g., increased shelf life and thermal stability, means that the stable peracid compositions retain a relatively high level of peracid over a given period of time. In this regard, the total concentration of peracids after one month of storage at 25° C. should be no lower than 60%, preferably at least 80%, more preferably at least 85% of the maximum concentration thereof. After three months of storage at 4° C. the concentration of peracids should be no lower than 90% of the maximum concentration thereof.

### The Process for Preparing the Antimicrobial Composition

The invention further comprises a process for preparing the inventive aqueous antimicrobial composition, comprising mixing the first and the second carboxylic acids with an aqueous hydrogen peroxide solution and optionally an inorganic acid, optionally reacting the components for a time sufficient for achieving equilibrium followed by optional dilution of the obtained mixture with water.

The inorganic acid, preferably the one described above as a component of the inventive composition, can serve as a catalyst for the reaction of carboxylic acids with hydrogen peroxide and may facilitate achieving the equilibrium state of the inventive composition.

In the inventive process, the components of the composition (carboxylic acids and hydrogen peroxide) are preferably reacted until achieving the equilibrium concentration of peracids. However, achieving of the equilibrium concentrations of peracids is not necessary. In most cases, for achieving adequate antimicrobial performance of the resulting composition, it is sufficient that at least 10%, more preferably at least 20% of the maximal concentration the corresponding percarboxylic acids is achieved.

The rate of achieving the equilibrium in the inventive composition depends on the temperature employed for reacting the components thereof and the concentrations of the components in the composition.

The process of the invention is preferably carried out at 0° C. to 50° C., more preferably at 4° C. to 30° C., more preferably at 10° C. to 25° C.

The duration of the inventive process may be from 1 minute to 8 weeks, preferably from 10 minutes to 4 weeks, more preferably from 1 hour to 2 weeks.

The inventive process usually involves mixing the first and the second carboxylic acids with an aqueous hydrogen peroxide solution followed by dilution of the obtained (concentrated) mixture with water prior to its use in antimicrobial treatment.

In the process according to the invention, the employed aqueous hydrogen peroxide solution may have a concentration of up to 100% by weight of H₂O₂, preferably at least 25% by weight, more preferably 30-75% by weight.

The initial concentration of hydrogen peroxide in the obtained concentrated mixture may range from 2 wt % to 60 wt % by weight. In the final concentrated composition after achieving the equilibrium, the concentration of hydrogen peroxide is typically from 1 wt % to 40 wt %.

The molar ratio of the employed in the inventive process hydrogen peroxide to the sum of the first and the second carboxylic acids is usually from 0.5:1 to 4:1, preferably 0.8:1 to 3:1, more preferably 1:1 to 2.5:1.

The process of the invention may comprise mixing:
a) 5-25 wt %, preferably 7-20 wt % of the first carboxylic acid;
b) 20-50 wt %, preferably 25-40 wt % of the second carboxylic acid;
c) 10-40 wt %, preferably 12-30 wt % of hydrogen peroxide, calculated as 100% H₂O₂;
d) optionally 0.2-5 wt %, preferably 0.5-3 wt % of an inorganic acid;
e) optionally 0.1-5 wt %, preferably 0.2-2 wt % of a stabilizer;
f) water (balance to 100%),
   wherein molar ratio of the first carboxylic acid to the second carboxylic acid is from 1:5 to 5:1, preferably from 1:3 to 3:1, more preferably 1:2 to 2:1
   to obtain after the required reaction time a concentrated antimicrobial composition, which upon further dilution with water will result in a diluted antimicrobial composition.

It was found that an excess of water may degrade the peracid in diluted compositions and that minimizing amounts of water in the concentrated compositions usually enhances their stability. Thus, the amount of water in the concentrated compositions of the invention is preferably less than 60 wt %, more preferably less than 40 wt % of the composition.

Method of Use of the Aqueous Antimicrobial Composition The invention further comprises a method of use of the inventive antimicrobial composition for an antimicrobial treatment, especially of a food product, a hard surface or an aseptically packed beverage, of water used for washing or processing thereof, as well as in areas including food plants, kitchens, bathrooms, factories, hospitals, and dental offices.

The composition of the present invention is a particularly effective antimicrobial agent. While not wishing to be bound by any theory of operation, it appears that the molecules of the second percarboxylic acid used in the blends have a better compatibility with the surface of the meat proteins or other foods compared to the first percarboxylic acid, e.g. peracetic and performic acid. The second percarboxylic acid thus acts to bring the peroxy groups into a closer contact with the microbial subjects for purposes of sanitizing.

The suitable food product may be selected from a vegetable, fruit or grain, meat protein, red meat such as beef, poultry, seafood.

The suitable hard surface may be selected from a cutting board, sink, cutting blade, conveyor, picker, bird washer, on-line or off-line processing equipment, a carcass, hide or flume.

The antimicrobial treatment with the inventive composition carried out for at most 1 minute, more preferably for at most 30 seconds at 20-25° C. is usually sufficient to reduce the microbial contamination by at least 50%, preferably by at least 70%, more preferably by at least 90%.

The duration of the antimicrobial treatment is preferably chosen so that the microbial contamination is reduced by at least 50%, preferably by at least 70%, more preferably by at least 90%.

The described antimicrobial treatment is preferably effective at killing one or more of the food-borne pathogenic bacteria associated with a food product, including, but not limited to Salmonella typhimurium, Salmonella javiana, Campylobacter jejuni, Listeria monocytogenes, and Escherichia coli, as well as yeasts, molds, and spores.

The compositions of the present invention can kill a wide variety of microorganisms on a surface of food processing equipment, on the surface of a food product, in water used for washing or processing of food product, on a health care surface, or in a health care environment. This combination of peracids has been found to provide optimal antimicrobial efficacy and stability in the presence of high organic loads.

The inventive antimicrobial composition may be provided as a concentrate for mixing with water at the point of use. Normally, the antimicrobial compositions of the present invention will be employed using conventional equipment and at a temperature of approximately 0-70° C. The composition should preferably be diluted to 50-10,000 ppm of active peracid concentration before use and contact with the foods or surfaces of food processing equipment or other contaminated surfaces should usually be maintained for not less than five seconds.

The diluted solution can be applied by washing, dipping, spraying and other standard methods used in meat processing. The diluted compositions can be applied in batch or continuous processes and are suitable for use in automated processes, thereby reducing cost for the food processing plant and improving the safety for workers.

### EXAMPLES

The following examples are presented to offer further illustration of the present invention but are not intended to limit the scope of the invention in any manner whatsoever.

### Preparation of Test Solutions

Solutions of peracids were prepared by dissolving the appropriate weight of the carboxylic acids in the aqueous hydrogen peroxide (70% solution manufactured by PeroxyChem LLC). De-ionized (DI) water was then added to obtain the desired concentrations. All the solutions were clear and homogeneous when initially prepared and remained so for the duration of the experiment.

The concentrations of formed peracids and hydrogen peroxide were monitored by titration on an auto-titrator and by using Chemetrics test kits K7913F and K-5543.

### Comparative Example 1

Two solutions were prepared using solid citric acid (47.9 wt %), 70 wt % hydrogen peroxide (21.8 wt %) and the rest DI water. 0.6 wt % Dequest 2010 stabilizer was added to both solutions. To the first solution (PCA-1), 4.9 wt % concentrated sulfuric acid was added as a catalyst. To the second solution (PCA-2), 0.6 wt % of sulfuric acid was added. Both solutions were kept at room temperature and periodically tested for the concentration of the components using an auto-titrator and standard titration methods. Concentrations of the components are shown in the Table 1.

TABLE 1
Formation and Stability of Peroxycitric acid

| | | Concentration, Moles/kg | | | | | | |
|---|---|---|---|---|---|---|---|---|
| Composition | Component | 1 day | 3 days | 7 days | 14 days | 22 days | 32 days | 46 days |
| PCA-1 | Peracid | 1.063 | 1.269 | 1.082 | 0.832 | 0.601 | 0.409 | 0.221 |
| | H₂O₂ | 3.647 | 3.176 | 2.765 | 2.176 | 1.647 | 1.118 | 0.647 |
| PCA-2 | Peracid | 0.337 | 0.668 | 0.822 | 0.707 | 0.644 | 0.490 | 0.365 |
| | H₂O₂ | 4.265 | 3.941 | 3.500 | 3.029 | 2.706 | 2.206 | 1.735 |

Percitric acid (PCA) was formed by a reaction of citric acid with hydrogen peroxide in the presence of H₂SO₄ catalyst. As shown in Table 1, maximum concentrations of PCA were reached after a few days. The maximum concentration was higher with a higher percent of the catalyst. However, in both cases, decomposition of PCA started after reaching a maximum, so that afterwards concentrations of both PCA and hydrogen peroxide decreased significantly. The data shown in the Table 1 demonstrates instability of PCA over time at ambient temperature.

### Example 1

Peracid blends were prepared as described in the comparative example 1, but instead of citric acid alone, a mixture of carboxylic acids was used. The compositions of the blends are shown in the Table 2. Solid citric acid, glacial acetic acid, 85% aqueous lactic acid, and concentrated sulfuric acid were used. Stability of the compositions is shown in the Table 3.

TABLE 2
Composition of Peracid Blends

| | Concentration, wt % | | |
|---|---|---|---|
| Component | PCA-1 | PCA-3 | PCA-4 |
| Citric Acid (second carboxylic acid) | 48.0 | 38.0 | 38.0 |
| Acetic Acid (first carboxylic acid) | 0.0 | 4.4 | 10.0 |
| Lactic Acid (first carboxylic acid) | 0.0 | 4.7 | 4.7 |
| Sulfuric Acid | 4.9 | 1.0 | 1.0 |
| Dequest | 0.6 | 0.6 | 0.6 |
| H₂O₂, 70% | 21.8 | 30.0 | 24.4 |
| DI Water | 24.7 | 21.3 | 21.3 |
| molar ratio of first carboxylic | / | 1/1.6 | 1.1/1 |
| acid to second carboxylic acid | | | |

As can be seen from the stability data, blended peracids PCA-3 and PCA-4 are considerably more stable than percitric acid PCA-1, which is unexpected.

TABLE 3
Formation and Stability of PCA Blends at Room Temperature

Peracid Concentration, moles/kg

| Peracid Blend | 2 days | 7 days | 15 days | 30 days |
|---|---|---|---|---|
| PCA-1 | 1.269 | 1.082 | 0.832 | 0.409 |
| PCA-3 | 1.005 | 1.298 | 1.298 | 1.087 |
| PCA-4 | 1.207 | 1.346 | 1.293 | 1.149 |

### Example 2

The effect of peracids and peracid blends on microbial viability was assayed using a suspension testing method as described below.

Inoculum Preparation. Salmonella enterica ATCC 14028 or E. coli 8739, as model Gram-negative bacteria, were grown in trypticase soy broth for approximately 24 hours at 35° C. Then the suspension was diluted at a ratio 1:10 with Butterfield's buffer. This diluted suspension was added to sterile fetal bovine serum at a ratio 1:1 in order to produce a working inoculum containing 50% organic load. The further dilution of the working inoculum into the test matrix at a 1:10 ratio resulted in a 5% organic load.

Test solutions. The peracid solutions tested were prepared by diluting the concentrated solutions (PCA-1, PCA-3 and PCA-4) with deionized water to the desired concentration. The concentrates were freshly prepared and used right after the maximum concentration was reached.

Test method. 9 mL aliquots of the test solutions were added to a sterile centrifuge tube using sterile disposable serological pipettes. Then, a 1 mL aliquot of working inoculum was added to the test solution and vortexed briefly to mix. A 1 mL aliquot was removed from the mixture at specific time points following inoculation, and immediately added to a 9 mL volume of Letheen neutralizing broth containing 0.5% sodium thiosulfate. This broth was then shaken to mix, sonicated for 5 minutes, vortexed for 30 seconds, diluted serially into Butterfield's buffer, and the dilutions plated on 3M™ Petrifilm™ Aerobic Count Plates (APC). The plates were incubated for 48 hours at 35° C., and then counted manually. Log₁₀ calculations were performed to obtain the Log₁₀ CFU/mL of the solutions at each time point. The results of this experiment are shown in Table 4.

TABLE 4
Antimicrobial Efficacy of Treatments with Diluted
Peracids from Fresh Percitric-based Compositions

| | Compo- | PCA, | Treatment | Log₁₀ | Log₁₀ |
|---|---|---|---|---|---|
| Micros | sition | Moles/kg | Time, min | control | reduction |
| Salmonella | PCA-1 | 2.40 × 10⁻⁴ | 5 | 6.6 | 0 |
| Salmonella | PCA-1 | 2.40 × 10⁻⁴ | 15 | 6.6 | 0 |
| Salmonella | PCA-1 | 4.81 × 10⁻⁴ | 5 | 6.6 | 0.7 |
| Salmonella | PCA-1 | 4.81 × 10⁻⁴ | 15 | 6.6 | 3.0 |
| Salmonella | PCA-3 | 2.40 × 10⁻⁴ | 5 | 6.6 | Total kill |
| Salmonella | PCA-4 | 2.40 × 10⁻⁴ | 5 | 6.6 | Total kill |
| E. coli | PCA-1 | 2.40 × 10⁻⁴ | 5 | 6.4 | 0.3 |
| E. coli | PCA-1 | 2.40 × 10⁻⁴ | 15 | 6.4 | 0.5 |
| E. coli | PCA-3 | 2.40 × 10⁻⁴ | 5 | 6.5 | Total kill |
| E. coli | PCA-4 | 2.40 × 10⁻⁴ | 5 | 6.5 | Total kill |

As the data in the Table 4 show, the percitric acid-based compositions are all effective against Salmonella enterica and E. coli. For the composition of percitric only, e.g., PCA-1, higher concentrations and longer times were needed to achieve meaningful microbial reductions. However, it was unexpectedly found that the percitric acid blends with smaller molecule organic acids than citric acid, the precursor of the percitric acid, e.g., PCA-3 and PCA-4, demonstrated superior antimicrobial efficacy at lower concentration and shorter treatment time.

### Example 3

In this test, the effect of peracids on microbial viability was assayed using a carrier-based dip testing method as described below. A carrier allows the microorganisms to attach and usually makes them tougher to kill by an antimicrobial agent, which better simulates the real-world situation. Another aspect of this example is to compare the efficacy of percitric acid-based composition in this disclosure vs. that of the popular peracetic acid-based formulation. Test conditions are chosen to model industrial high-speed processing operations, such as poultry antimicrobial interventions and aseptic packaging machine, where high concentration of antimicrobial agents is typically used in order to achieve satisfactory efficacy within very short treatment time. At such high use concentration, it has been a real industrial hygiene concern with the peracetic acid-based formulations due to the distinct smell from the acetic and peracetic acid components.

Salmonella enterica 14028 and Bacillus atrophaeus 9372 (as model Gram positive and spore forming bacterium) were used in the experiments. 10 μL of inoculated suspension was placed using a pipet onto sterile stainless-steel foil strips and allowed to dry overnight. Peracetic acid (PAA) with nominal contents of 22 wt % PAA and 10 wt % H₂O₂ (22/10 PAA) was used for a comparison. Peracid test solutions were diluted to specified concentration. 50 mL of PAA or PCA-4 solution were added to sterile centrifuge tube. Dried strips were dipped into Peracid solution for a designated time. Treatment with Salmonella was done at 22° C., and with Bacillus spores at 55° C.

The strips were then neutralized in 10 mL Letheen broth+0.5% sodium thiosulfate. The centrifuge tubes were capped and shaken. Neutralizer tubes were sonicated for 5 minutes, and then vortexed for 30 seconds. Standard serial dilutions were completed using Butterfield's buffer, plating was performed using Petrifilm APC and incubated at 35° C. for 48 hours. The results are given in Table 5.

TABLE 5
Average Log₁₀ Reduction: PAA and PCA Formulations

| | | Concentration, | Time, | Log₁₀ | Log₁₀ |
|---|---|---|---|---|---|
| Organism | Peracid | moles/kg | seconds | control | reduction |
| Salmonella | PAA | 6.58 × 10⁻³ | 5 | 6.5 | 0.6 |
| Salmonella | PAA | 6.58 × 10⁻³ | 10 | 6.5 | 1.8 |
| Salmonella | PCA-4 | 1.20 × 10⁻² | 5 | 6.5 | 1.5 |
| Salmonella | PCA-4 | 1.20 × 10⁻² | 10 | 6.5 | 2.2 |
| B. | PAA | 6.58 × 10⁻³ | 10 | 6.3 | 1.5 |
| atrophaeus | | | | | |
| B. | PAA | 6.58 × 10⁻³ | 15 | 6.3 | 2.0 |
| atrophaeus | | | | | |
| B. | PCA-4 | 1.20 × 10⁻² | 10 | 6.3 | 1.2 |
| atrophaeus | | | | | |
| B. | PCA-4 | 1.20 × 10⁻² | 15 | 6.3 | 1.7 |
| atrophaeus | | | | | |

The data in the Table 5 show that the PCA composition can provide similar Log₁₀ reductions of Salmonella enterica and Bacillus atrophaeus in a short (5-15 seconds) dip treatment vs. PAA, though at a higher concentration considering that molecular weight of PCA is about 3 times higher than that of PAA. A major difference for such concentrated solutions of peracids is that PCA does not have any odor as opposed to PAA at the tested dosing levels.

The PAA solution had a distinct odor of acetic/peracetic acid. Solution of PCA-4 had no odor. It was an unexpected finding that PCA-4 had no odor at such high concentration as it is blended with components of acetic and lactic acids that have distinct smells by themselves. Without wishing to be bound by any particular theory, it is believed that citric acid is able to help bound the components within the liquid matrix and reduce the vapor pressure that leads to smells for the organic acids of smaller molecules.

### Example 4

As an attempt to further quantify the odor of various peracids, in this example a Draeger Gas Detection Tube was used to capture the volatile acidic components near the solution surface that produce odor.

Percitric acid-based compositions, PCA-3 and PCA-4, were diluted close to the top in 1000 ml beakers to a concentration of 1.32×10⁻² and 1.33×10⁻² moles/kg respectively. As baselines for comparison, 22/10 PAA was diluted in the similar way to about 1.25×10⁻² moles/kg under two conditions—(1) the diluted solution remained as-is without further adjustment, and (2) the diluted solution was pH adjusted to 8 with NaOH, which is expected to lock volatile components of acetic acid and PAA in a de-protonated (i.e., salt) forms in the solution and lead to reduced odor. Considering the molecular weight differences, the above concentrations of PAA and PCA are about equivalent in moles.

A magnetic stirrer was used to keep the solutions moving at constant speed throughout test. Once the system was running steady, a Draeger tube with a handpump was positioned close to the surface of the solution to measure the total volatile acids emitted from the solution.

As shown by data in Table 6, the PCA with mixed acids indeed had lower total volatile acid readings than that of the PAA without pH adjustment but were equivalent to the reading of PAA at pH 8. This example has further confirmed the unexpected finding that PCA with mixed acid had no detectable odor at a high concentration despite that it is blended with components of acetic and lactic acids that have distinct smells. Without wishing to be bound by any particular theory, it is believed that citric acid is able to help bound the components within the liquid matrix and reduce the vapor pressure that leads to smells for the organic acids of smaller molecules.

TABLE 6
Total Acids Readings from Draeger Gas Detection Tube

| PAA based formulations | | | | | |
|---|---|---|---|---|---|
| | No pH | | PCA with mixed acids | | |
| | adjustment | at pH 8 | | PCA-3 | PCA-4 |
| | Detection | Detection | | Detection | Detection |
| PAA | Tube | Tube | | Tube | Tube |
| concentration | Reading | Reading | PCA concentration | Reading | Reading |
| (Moles/kg) | (ppm) | (ppm) | (Moles/kg) | (ppm) | (ppm) |
| 1.25 × 10⁻² | 0.5 | 0.3 | 1.32 × 10⁻² (PCA-3) | 0.2 | 0.3 |
| | | | 1.33 × 10⁻² (PCA-4) | | |

### Example 5

In this example tests are conducted to simulate a spray or dip intervention typically used in process plants for the reduction of foodborne pathogens on raw meats with an antimicrobial agent, such as PAA. The combinations of raw meat types and foodborne pathogens are:

Raw pork butts: Salmonella spp., Campylobacter spp., and Listeria monocytogenes

Raw beef trim: Salmonella spp. and Escherichia coli O157:H7

Raw chicken thighs: Campylobacter spp.

Raw chicken tenders: Campylobacter spp.

Raw chicken wings: Campylobacter spp.

### Foodborne Pathogen Inocula are Prepared in the Following Ways:

Salmonella spp., E. coli O157:H7, and L. monocytogenes

Five different strains of each foodborne pathogen are prepared by streaking from −80° C. frozen cultures on to Tryptic Soy Agar (TSA) plates, incubating the TSA plates for 18-24 hours at 35° C., transferring a loopful of growth from TSA plates into Tryptic Soy Broth (TSB) tubes, incubating the TSB tubes for 18-24 hours at 35° C., and then combining equal volumes of the TSB cultures of that particular foodborne pathogen to make a five-strain cocktail for that foodborne pathogen with an estimated concentration of ˜9.0 log 10 CFU/ml. Once each five-strain cocktail is prepared, it is enumerated to verify its concentration of viable cells.

### Campylobacter spp.

A five-strain cocktail of Campylobacter spp. strains are prepared by streaking from −80° C. frozen Cryobead cultures onto Tryptic Soy Agar with 5% Sheep Blood (TSA+SB) plates, incubating the TSA+SB plates for 46 to 50 hours at 42° C. under microaerophilic conditions, transferring a loopful of growth from TSA+SB plates into Single Strength Bolton Broth supplemented with Sterile Laked Horse Blood (SSBB+HB) tubes, incubating the SSBB+HB tubes for 46 to 50 hours at 42° C. under microaerophilic conditions, and then combining equal volumes of the SSBB+HB cultures to make a five-strain cocktail of Campylobacter spp with an estimated concentration of ˜9.0 log 10 CFU/ml. Once the five-strain cocktail is prepared, it is enumerated to verify its concentration of viable cells.

### Inoculation of Raw Meats is Conducted in the Following Ways.

For raw pork butts and raw beef trim, a 100 cm² area is demarcated on each sample. This 100 cm² area is then inoculated with 100 ul of the ˜9.0 log 10 CFU/ml five-strain cocktail of one particular foodborne pathogen (i.e., multiple foodborne pathogens are not be co-inoculated onto one sample) and is spread with a sterile spreader to provide a starting concentration of ˜5.0 to 6.0 log 10 CFU/cm² of cells as the starting concentration for the sample. The bacteria are then allowed to attach to these samples at −50° F. for 30 min.

For raw chicken thighs, raw chicken tenders, and raw chicken wings a sample consists of four thighs, tenders, or wings. Each set of four thighs, tenders, or wings is inoculated with 1 ml of the ˜9.0 log 10 CFU/ml five-strain cocktail of one particular foodborne pathogen and is spread with a sterile spreader to provide a starting concentration of ˜8.0 to 9.0 CFU/sample of cells as the starting concentration for the sample. The bacteria will then be allowed to attach to these samples at −50° F. for 30 min.

### Treatment Methods

For raw pork butts and raw beef trim: The treatment is applied by spraying water only (as a control) or an antimicrobial solution for 5 seconds onto the raw meats, and then the samples are allowed to dwell for 10 minutes before sampling is performed. After this 10 min period, the samples are promptly removed from the application zone, and any excess of water or the solution is shaken off or drained. After treatments are performed, each 100 cm² area is sampled with a Hydrasponge that is pre-hydrated with Dey/Engley Neutralizing Broth. These sponge samples are then be homogenized and D/E Broth from these sponge samples are then be subjected to the enumeration procedures provided below.

For raw chicken thighs, raw chicken tenders, and raw chicken wings: The treatment is applied by dipping in a dip bath of water only (as a control) or an antimicrobial soliton for 20 seconds. After this dip treatment, the samples are moved out of the dip bath and allowed to dwell for 10 min before sampling is performed. After this 10 min dwell period, the samples are promptly removed from the application zone, and any excess of water or the solution is shaken off or drained. After treatments are performed, each set of three parts is rinsed with 100 ml of Dey/Engley Neutralizing Broth (D/E Broth). This D/E Broth rinse liquid is then be enumerated according to the procedures provided below.

### Enumeration for Each Organism is Performed as Described Below

Salmonella spp.: D/E Broth is serially diluted in Butterfield's Phosphate Buffer (BPB) in order to obtain dilutions that will yield countable plates and spread-plated to plates of Xylose Lysine Deoxycholate Agar (XLD) that has been overlaid with a thin layer of TSA (XLD+TSA). The XLD+TSA plates will then be incubated for 24 hours at 35° C. before being counted.

E. coli O157:H7: D/E Broth is serially diluted in BPB in order to obtain dilutions that will yield countable plates and spread-plated to plates of Cefixime Tellurite Sorbitol MacConkey Agar (CT-SMAC) that has been overlaid with a thin layer of TSA (CT-SMAC+TSA). The CT-SMAC+TSA plates will then be incubated for 24 hours at 35° C. before being counted.

L. monocytogenes: D/E Broth is serially diluted in BPB in order to obtain dilutions that will yield countable plates and spread-plated to plates of Modified Oxford Agar (MOX) that has been overlaid with a thin layer of TSA (MOX+TSA). The MOX+TSA plates will then be incubated for 48 hours at 35° C. before being counted.

Campylobacter spp.: D/E Broth is serially diluted in BPB in order to obtain dilutions that will yield countable plates and spread-plated to plates of Campy-Cefex Agar (CC) that has been overlaid with a thin layer of TSA (CC+TSA). The CC+TSA plates will then be incubated for 48 hours at 42° C. under microaerophilic conditions before being counted.

### Test Results

Diluted solutions of 22/10 PAA and percitric acid blends PCA-4 were tested according to the above described methods to compare antimicrobial efficacies on foodborne pathogens inoculated raw meats. The results are summarized in tables 7, 8, and 9.

For peracid chemistries, the per-carboxylic groups are commonly recognized as the active species to attack the microbes. So, in order to obtain comparable antimicrobial efficacies, the peracid concentration are expected to be similar. Surprisingly, the test data shown in tables 7, 8, and 9 have clearly demonstrated superior efficacy of percitric acid blend PCA-4 at a lower concentration than that of the peracetic acid 22/10 PAA on various raw meats inoculated with various foodborne pathogens. Without being bound by any particular theory, it is believed that the longer chain molecules of percitric acid with 6 carbon have a better attachment to the raw meat surfaces than the simple molecules of peracetic acid with 2 carbon and eventually lead to a better performance.

TABLE 7
Antimicrobial Treatment of Beef Trim with PAA or PCA-4

| | | Pathogen | | | | | |
|---|---|---|---|---|---|---|---|
| | | Salmonella spp. | | | E. coli O157:H7 | | |
| Treatment solution | | PAA | PAA | PCA-4 | PAA | PAA | PCA-4 |
| Peracid content, | | 9.21 × | 5.32 × | 3.49 × | 9.20 × | 5.37 × | 3.48 × |
| moles/kg | | 10⁻³ | 10⁻³ | 10⁻³ | 10⁻³ | 10⁻³ | 10⁻³ |
| Reduction in | | 1.2 ± | 1.1 ± | 1.4 ± | 1.0 ± | 0.9 ± | 1.3 ± |
| Pathogen, Log₁₀ | | 0.4 | 0.2 | 0.4 | 0.3 | 0.3 | 0.2 |
| Control (water), | | 5.9 ± | 6.4 ± | 6.3 ± | 6.7 ± | 6.6 ± | 6.6 ± |
| Log₁₀ | | 0.3 | 0.5 | 0.5 | 0.5 | 0.3 | 0.3 |
| Sample | Control | 15 | 15 | 20 | 20 | 10 | 10 |
| numbers | Treatment | 30 | 30 | 30 | 30 | 30 | 30 |

TABLE 8
Antimicrobial Treatment of Pork Butts with PAA or PCA-4

| | | Pathogen | | | | | | | | |
|---|---|---|---|---|---|---|---|---|---|---|
| | | Salmonella spp. | | | Campylobacter spp. | | | L. monocytogenes | | |
| Treatment | | PAA | PAA | PCA-4 | PAA | PAA | PCA-4 | PAA | PAA | PCA-4 |
| Peracid content, | | 9.34 × | 5.32 × | 3.48 × | 9.30 × | 5.47 × | 3.35 × | 9.42 × | 5.51 × | 3.50 × |
| moles/kg | | 10⁻³ | 10⁻³ | 10⁻³ | 10⁻³ | 10⁻³ | 10⁻³ | 10⁻³ | 10⁻³ | 10⁻³ |
| Reduction in | | 0.9 ± | 0.9 ± | 1.2 ± | 1.0 ± | 0.5 ± | 1.0 ± | 1.2 ± | 1.1 ± | 0.9 ± |
| Pathogen, Log₁₀ | | 0.6 | 0.4 | 0.3 | 0.5 | 0.5 | 0.5 | 0.4 | 0.4 | 0.2 |
| Control (water), | | 6.2 ± | 6.4 ± | 6.4 ± | 4.6 ± | 4.7 ± | 4.7 ± | 6.7 ± | 6.7 ± | 6.7 ± |
| Log₁₀ | | 0.4 | 0.5 | 0.3 | 0.4 | 0.2 | 0.2 | 0.3 | 0.1 | 0.1 |
| Sample | control | 18 | 20 | 10 | 20 | 10 | 10 | 20 | 10 | 10 |
| numbers | treatment | 29 | 30 | 30 | 30 | 30 | 30 | 30 | 30 | 30 |

TABLE 9
Antimicrobial Treatment of Campylobacter spp. inoculated Chicken Parts with PAA or PCA-4

| | | Chicken parts | | | | | | | | |
|---|---|---|---|---|---|---|---|---|---|---|
| | | Chicken Tenders | | | Chicken Thighs | | | Chicken Wings | | |
| Treatment | | PAA | PAA | PCA-4 | PAA | PAA | PCA-4 | PAA | PAA | PCA-4 |
| Peracid content, | | 9.50 × | 5.21 × | 3.26 × | 9.21 × | 5.35 × | 3.30 × | 9.10 × | 5.34 × | 3.39 × |
| moles/kg | | 10⁻³ | 10⁻³ | 10⁻³ | 10⁻³ | 10⁻³ | 10⁻³ | 10⁻³ | 10⁻³ | 10⁻³ |
| Reduction in | | 1.0 ± | 0.6 ± | 1.3 ± | 0.8 ± | 0.6 ± | 1.3 ± | 1.0 ± | 0.9 ± | 1.1 ± |
| Pathogen, Log₁₀ | | 0.3 | 0.2 | 0.3 | 0.2 | 0.2 | 0.3 | 0.2 | 0.2 | 0.2 |
| Control (water), | | 4.9 ± | 4.9 ± | 4.9 ± | 5.3 ± | 5.5 ± | 5.5 ± | 5.4 ± | 5.7 ± | 5.0 ± |
| Log₁₀ | | 0.2 | 0.2 | 0.1 | 0.3 | 0.2 | 0.2 | 0.4 | 0.3 | 0.2 |
| Sample | control | 20 | 10 | 10 | 15 | 15 | 20 | 20 | 10 | 10 |
| numbers | treatment | 30 | 30 | 30 | 30 | 30 | 30 | 30 | 30 | 30 |

1. An aqueous antimicrobial composition, comprising:
(a) a first carboxylic acid with a boiling point at standard pressure of below 180° C.,
(b) a second carboxylic acid comprising at least two carboxylic groups,
(c) a first percarboxylic acid derived from the first carboxylic acid,
(d) a second percarboxylic acid derived from the second carboxylic acid,
(e) hydrogen peroxide,
wherein a molar ratio of a sum of the first carboxylic acid and the first percarboxylic acid to a sum of the second carboxylic acid and the second percarboxylic acid is from 1:5 to 5:1, wherein the composition further comprises an inorganic acid.

2. The composition according to claim 1, wherein the molar ratio of the sum of the first carboxylic acid and the first percarboxylic acid to the sum of the second carboxylic acid and the second percarboxylic acid is from 1:4.5 to 4.5:1.

3. The composition according to claim 1, wherein the first carboxylic acid is at least one selected from the group consisting of formic acid, acetic acid, glyoxylic acid, glycolic acid, pyruvic acid, lactic acid, and mixtures thereof.

4. The composition according to claim 1, wherein the second carboxylic acid is at least one selected from the group consisting of maleic acid, malic acid, tartaric acid, malonic acid, citric acid and mixtures thereof.

5. The composition according to claim 1, wherein the inorganic acid is at least one selected from the group consisting of sulfuric acid, methane sulfonic acid, phosphoric acid, and nitric acid.

6. The composition according to claim 1, wherein the content of percarboxylic acids in the composition is 10 ppm to 40 wt.-%, based on a total weight of the aqueous antimicrobial composition.

7. The composition according to claim 1, wherein a molar ratio of the (carboxylic acids):(percarboxylic acids):(hydrogen peroxide) is (1.0-6.0):(1.0):(0.5-4.0).

8. A process for preparing the antimicrobial composition according to claim 1, comprising:
mixing the first and the second carboxylic acids with an aqueous hydrogen peroxide solution and an inorganic acid, optionally reacting the components for a time sufficient for achieving equilibrium, followed by optionally diluting the obtained mixture with water.

9. The process according to claim 8, wherein the employed aqueous hydrogen peroxide solution has a concentration of at least 20% by weight of H₂O₂.

10. The process according to claim 8, wherein the following ingredients are mixed, comprising:
a) 5-25 wt % of the first carboxylic acid;
b) 20-50 wt % of the second carboxylic acid;
c) 10-40 wt % of hydrogen peroxide, calculated as 100% H₂O₂;
d) 0.2-5 wt % of an inorganic acid;
e) optionally 0.1-5 wt % of a stabilizer; and
f) water.

11. A method of sanitizing in areas including food plants, kitchens, bathrooms, factories, hospitals, and dental offices, comprising: treating a surface with the aqueous antimicrobial composition according to claim 1.

12. The method according to claim 11, wherein the antimicrobial treatment is carried out for at most 1 minute at 20-25° C. and is sufficient to reduce the microbial contamination by at least 50%.

13. The method according to claim 11, wherein the surface is at least one food product selected from the group consisting of a vegetable, a fruit, a grain, a meat protein, red meat, poultry, and seafood.

14. The method according to claim 11, wherein the surface is at least one hard surface selected from the group consisting of a cutting board, a sink, a cutting blade, a conveyor, a picker, a bird washer, on-line or off-line processing equipment, a carcass, a hide, and a flume.

15. The method according to claim 11, wherein the antimicrobial treatment is effective at killing at least one of the food-borne pathogenic bacteria associated with a food product selected from the group consisting of Salmonella typhimurium, Salmonella javiana, Campylobacter jejuni, Listeria monocytogenes, and Escherichia coli, as well as yeasts, molds, and/or spores.

16. The composition according to claim 1, wherein the molar ratio of the sum of the first carboxylic acid and the first percarboxylic acid to the sum of the second carboxylic acid and the second percarboxylic acid is from 1:4 to 4:1.

17. The composition according to claim 1, wherein the molar ratio of the sum of the first carboxylic acid and the first percarboxylic acid to the sum of the second carboxylic acid and the second percarboxylic acid is from 1:3 to 3:1.

18. The composition according to claim 1, wherein the molar ratio of the sum of the first carboxylic acid and the first percarboxylic acid to the sum of the second carboxylic acid and the second percarboxylic acid is from 1:2 to 2:1.

19. The process according to claim 8, wherein the employed aqueous hydrogen peroxide solution has a concentration of at least 25% by weight of H₂O₂.

20. The process according to claim 8, wherein the employed aqueous hydrogen peroxide solution has a concentration of 30-75% by weight of H₂O₂.
